(19) United States
(12) Patent Application Publication
(10) Pub. No.: US 2014/0108087 A1
(43) Pub. Date: Apr. 17, 2014

(54) LOG MANAGEMENT SYSTEM AND LOG MANAGEMENT METHOD

(71) Applicant: HITACHI SOLUTIONS, LTD., Tokyo (JP)

(72) Inventors: Daisuke FUKUI, Tokyo (JP); Shinya SASAKI, Tokyo (JP)

(73) Assignee: HITACHI SOLUTIONS, LTD., Tokyo (JP)

(21) Appl. No.: 14/054,978

(22) Filed: Oct. 16, 2013

(30) Foreign Application Priority Data
Oct. 17, 2012 (JP) 2012-229721

(51) Int. Cl. G06Q 10/06

(52) U.S. Cl. CPC G06Q 10/06316
USPC 705/7.26

(57) ABSTRACT

A server system generates one thread with respect to a request for a process, and at the time, a thread local storage that is a dedicated area in which data used for the thread is stored is secured on a main storage device. Log tracking information that can uniquely identify output of a log from the start of output of the log to the end of output of the same is held in the thread local storage during a process of a session ID, a user ID, and a sequence number. When the log is output, the log tracking information is added to the log data to be output to an auxiliary storage device.

### CLAIM OF PRIORITY

The present application claims priority from Japanese patent application serial no. 2012-229721, filed on Oct. 17, 2012, the content of which is hereby incorporated by reference into this application.

### BACKGROUND OF THE INVENTION

1. Field of the Invention

The present invention relates to a log management system and a log management method, and particularly to a log management system and a log management method in which logs can be centrally managed without placing a load of software development on a system developer in a cluster system.

2. Description of the Related Art

In general, a server system is configured using plural machines. This configuration is referred to as “cluster configuration”, and each machine configuring the cluster is referred to as “cluster node”. By employing the cluster configuration, the server system can disperse a processing load, and can provide a standby function in which when a cluster node is down during a process, another cluster node takes over the process.

On the other hand, it is difficult in the server system with the cluster configuration to perform an operation (hereinafter, referred to as “debug”) of identifying the cause of a trouble of software being run at the time of occurrence of the trouble. The debug is generally performed using a dedicated software tool called “debugger”. However, the server system with the cluster configuration is a special system because plural cluster nodes perform a process in cooperation with each other, and thus the debug cannot be performed using the same method as normal software. For example, in order to perform the debug using the debugger for a server system configured using hundreds of cluster nodes, it is necessary to perform the debug by allowing the debugger to run on hundreds of cluster nodes. This operation is unrealistic, and thus the debug for the server system is generally performed by analyzing log data that is a record obtained by executing software. Specifically, when a trouble occurs, an operator of debug identifies the cause of the trouble by analyzing detailed information about the behavior of the server system included in the log data.

However, it is not generally easy to analyze the log data in the server system with the cluster configuration because the pieces of log data are dispersed and stored into plural cluster nodes due to the configuration of plural cluster nodes in the server system. Since the pieces of log data are dispersed as described above, an operator of debug needs to collect the dispersed pieces of log data by himself/herself and to separately analyze the same in the server system without taking any measures. This makes the debug operation difficult, thus becoming a factor for a long failure recovery time.

In addition, it is difficult to analyze the output format of log data in a general system. Specifically, the server system, in general, simultaneously processes plural requests from plural users in parallel. Accordingly, if the output format of log data in which the association with the user request can be identified is not employed, it is difficult to analyze the log data, thus becoming a factor for a long failure recovery time.

In order to solve the problems, a technique has been designed to shorten the time required to analyze the log data by collecting the dispersed pieces of log data in one area. For example, Japanese Unexamined Patent Application Publication No. 2010-512563 discloses a log file analyzing method in which log files existing in plural cluster nodes and having the same user identifier are divided into identifier files, so that log data can be easily analyzed to shorten the analysis time.

In the log file analyzing method described in Japanese Unexamined Patent Application Publication No. 2010-512563, log data can be analyzed for each user. However, it is not considered to simplify a detailed analysis for each request or each communication session. For example, when some failure occurs, log data needs to be analyzed on the basis of not only a user identifier (hereinafter, referred to as “user ID”) but also identification information (hereinafter, referred to as “session ID”) of a request in order to track the processing sequences until the failure occurs.

On the other hand, in order to realize an analysis of log data on the basis of the session ID, information (hereinafter, referred to as “log tracking information”) with which log data for each request can be tracked needs to be included in log data. General log tracking information includes a user ID, a session ID, and a sequence number (serial number indicating the output order of log data). However, the log tracking information is not limited to those as long as a request can be uniquely specified and the output order of the log can be identified.

Unlike general information (for example, date and time, a log level and the name of a thread) that is output as a log, the log tracking information cannot be established using only information that can be obtained at the time of log output. For example, if the processing sequence of a request differs, the sequence number becomes different even at the same log output section, and thus it is essential to manage the sequence numbers. The user ID and the session ID differ depending on a request. Thus, it is necessary to manage these pieces of information while being associated with the request.

Accordingly, a developer of a software module (hereinafter, referred to as “server module”) configuring a server system needs to implement logics to include the log tracking information in log data into the server module. However, it is not easy. In general, it is necessary to pass a pointer of a memory area in which the log tracking information is stored to parameters of all functions and methods. Therefore, it is possible that a load on a software developer is increased, the productivity of development of the server module is deteriorated, and the configuration of software of the server module is complicated.

The present invention has been made to solve the problems, and an object thereof is to provide a log management system in which logs can be efficiently analyzed for debug without deteriorating the productivity of development of a server module in a server system with a cluster configuration.

### SUMMARY OF THE INVENTION

According to the present invention, provided is a log management system including: a computer including a central processing unit, a main storage device, an auxiliary storage device, and a communication device; and another computer connected by the communication device via a network, the computer including a business logic processing unit that executes a process in response to a request from the other computer and a log output processing unit that executes a process related to output of log data that is a record of a process.

Upon receiving an output starting request of the log data from the business logic processing unit, the log output processing unit holds log tracking information that uniquely identifies a log from the start of output of log data to the end of output of the same into a Thread Local Storage (TLS) on the main storage device.

Upon receiving an output request of the log data from the business logic processing unit, the log output processing unit adds the log tracking information held in the thread local storage to a log output from the business logic processing unit to be output to the auxiliary storage device.

As described above, a thread that processes a request from a user is limited to a single thread to hold the log tracking information in the TLS in the log management method of the present invention. Specifically, as a structure of software, the structure of the server system is separated into the communication processing unit that performs a communication process and the business logic processing unit that performs other processes, and the communication processing unit having received a request from a user stores the log tracking information into the TLS.

On the other hand, the business logic processing unit outputs the log data using a dedicated library for log output. Inside the library for log output, the log tracking information stored in the TLS is obtained, and the log tracking information is added to the log data to be output to a file or the like. At the same time, the sequence number is increased inside the library for log output, and the log tracking information in the TLS is updated.

After the process for the request is completed, the communication processing unit deletes the log tracking information stored in the TLS. Through the series of processes, the log tracking information can be efficiently included in the log data without deteriorating the productivity of development of the server module.

As described above, according to the log management method of the present invention, logs can be easily tracked at the time of occurrence of failure, the time required to identify the cause of the failure can be shortened, and the operation rate of the server system is improved. In this case, the operation rate corresponds to a value obtained by dividing the value of Mean Time Between Failure (MTBF) by the sum of Mean Time To Repair (MTTR) and MTBF. MTBF is a mean time from the time the failure occurs to the time the next failure occurs, and MTTR is a mean time from the time the failure occurs to the time the failure is repaired. Specifically, by shortening the time required to identify the cause of the failure, the value of MTTR is decreased and the operation rate is improved.

Further, a developer of the server module can advance the development with little awareness of the log tracking information, and debug can be performed using the log tracking information even at the time of a test of the server module, thus improving the productivity of development of the server module.

According to the present invention, it is possible to provide a log management system in which logs can be efficiently analyzed for debug without deteriorating the productivity of development of a server module in a server system with a cluster configuration.

### BRIEF DESCRIPTION OF THE DRAWINGS

Preferred embodiments of the present invention will now be described in conjunction with the accompanying drawings, in which;

FIG. 1 is a functional configuration diagram of a log management system according to an embodiment of the present invention;

FIG. 2 is a hardware configuration diagram of a server machine, a client machine, a log management machine, and a storage machine in FIG. 1;

FIG. 3 is a sequence diagram for showing the start processing and end processing of log output;

FIG. 4 is a sequence diagram for showing a log output process;

FIG. 5 is a flowchart for showing a log collection process;

FIG. 6 is a diagram for explaining a management format in which log data with log tracking information added is stored in a table format of a database;

FIG. 7 is a diagram for showing a management screen for log data; and

FIG. 8 is a sequence diagram for showing a process of the system when a user searches for a log on the management screen for log data.

### DESCRIPTION OF THE PREFERRED EMBODIMENT

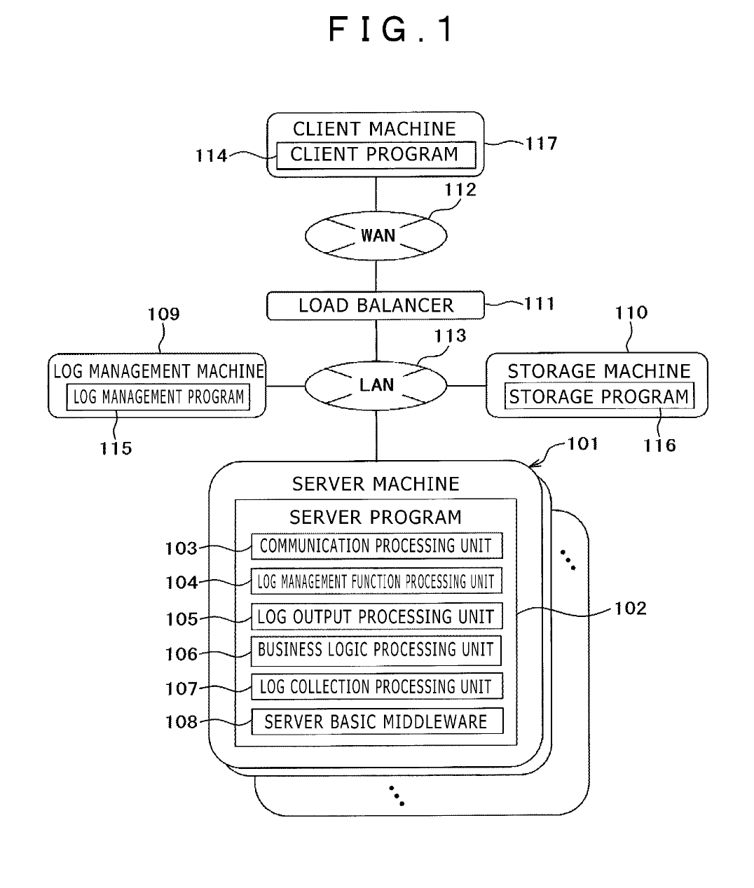

Hereinafter, an embodiment according to the present invention will be described using FIG. 1 to FIG. 8.

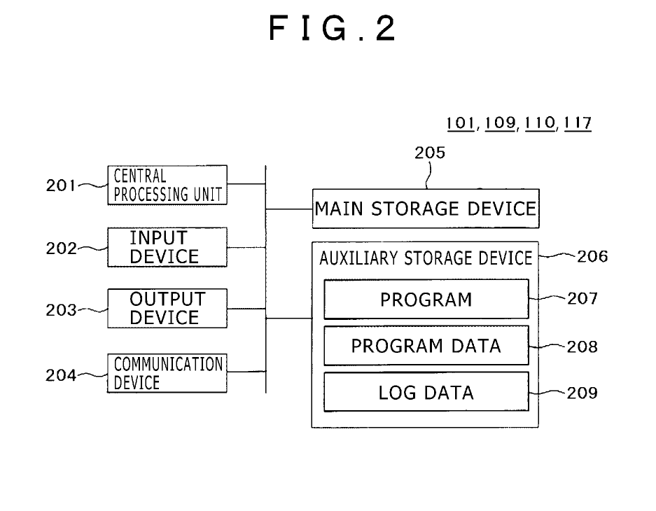

First, a configuration of a log management system according to an embodiment of the present invention will be described using FIG. 1 and FIG. 2.

In the log management system of the embodiment, as shown in FIG. 1, a plurality of server machines 101, a log management machine 109, a load balancer 111, and a storage machine 110 are connected to each other via a local area network (LAN) 113, and the load balancer 111 and a client machine 117 are connected to each other via a wide area network (WAN) 112.

The server machine 101 is a computer device that executes a server program 102. The server machine 101 may be a general personal computer (PC), or a dedicated machine specialized in server functions such as a blade server. Only one server machine 101 may be provided, or a cluster configuration in which plural server machines 101 are combined with each other may be provided. It should be noted that FIG. 1 illustrates the cluster configuration in which plural server machines 101 are combined with each other.

The server program 102 is a program that provides general server functions and outputs log data. As the types of server functions, there are, for example, an HTTP server that establishes Web sites, and a Mobile Device Management (MDM) server that provides an MDM function. The server program 102 is configured using a communication processing unit 103, a log management function processing unit 104, a log output processing unit 105, a business logic processing unit 106, a log collection processing unit 107, and server basic middleware 108.

The server basic middleware 108 is middleware that provides common basic functions necessary for a server system. Examples of the basic functions include a transaction management function, an asynchronous message distribution function, a thread pool management function and a cluster configuration management function. These are general functions, and a JBoss application server are known as middleware provided with the functions. The communication processing unit 103, the log management function processing unit 104, the log output processing unit 105, the business logic processing unit 106, and the log collection processing unit 107 are supposed to be implemented as server modules (modules known as Enterprise JavaBeans and Servlet) that run on the server basic middleware 108. The log output processing unit 105 can be implemented as a server module, as described above, or as a general library.

The server basic middleware 108 serves to manage a thread pool of threads that run on an OS, and the server module running on the server basic middleware 108 is not permitted to independently generate threads. This is a general specification for an application server such as JBoss. The server module having received a request from a client executes a process using a single thread allocated by the server basic middleware 108. The server system of the embodiment is supposed to perform a process in response to a request by the single thread, and is not permitted to allow the server module to independently generate threads similarly to the specification for a general application server.

The communication processing unit 103 performs data communications with the client machine 117, the log management machine 109, and the storage machine 110 via a network. The communication protocol is not limited to a special one, and may be Hyper Text Transfer Protocol (HTTP), Cpe WAN Management Protocol (CWMP), or the like. The communication processing unit 103 determines a server module to be called on the basis of the content of received data, and delegates a process to the server module.

As the networks to which the communication processing unit 103 is connected, the client side is connected to the communication processing unit 103 via the WAN 112 and the server side is connected to the communication processing unit 103 via the LAN 113 while assuming the load balancer 111 as a boundary. Communications between the client machine 117 and the server machine 101 are performed via the WAN 112 and the LAN 113. Communications among the log management machine 109, the storage machine 110, and the server machine 101 are performed via the LAN 113. It should be noted that the respective machines have different functions, and are communicated with each other via the networks in the above-described example, but all of the client machine 117, the log management machine 109, the storage machine 110, and the server machine 101 can be configured using the same machines. In this case, the communication processing unit 103 is operated as a pipeline of interprocess communications, and the load balancer 111 is not needed. Further, in the case of one server machine 101, the load balancer 111 is not similarly needed.

The log management function processing unit 104 is a server module that processes a search request of log data input from a log management program 115 and log management commands. As the types of log management commands, there are a command of deleting a log file, a command of collecting log data (collecting logs dispersed in clusters), and a command of setting collection schedules of log data. The log management function processing unit 104 searches a storage program 116 for log data on the basis of the log search request or the type of log management command. In order to collect the pieces of log data dispersed in the clusters, the log management function processing unit 104 delegates a process to the log collection processing unit 107. The execution result of the log management command is returned via the communication processing unit 103 to the log management program 115 having issued the command.

In response to an entry from the communication processing unit 103, the log output processing unit 105 stores log tracking information into a TLS. In response to an entry from a server module such as the business logic processing unit 106, the log output processing unit 105 outputs log data. The output log data is stored in a log file or the like that is shared by the server program 102.

The business logic processing unit 106 is a server module in which business logics (logics describing processes or rules unique to the server) of the server program 102 are implemented. In the case where the server program 102 is an MDM server program, the business logic processing unit 106 processes an inventory management function necessary for device management and an application distribution function. In response to a request from a client program 114 via the communication processing unit 103, the business logic processing unit 106 executes a process.

The log collection processing unit 107 collects the pieces of log data dispersed in the clusters. The log collection processing unit 107 regularly checks whether or not the log data stored by the log output processing unit 105 has been updated. If the log data has been updated, the log data is perpetuated using the storage program 116. In this case, the “perpetuation” means that even if a program that generates data is terminated, the data is prevented from disappearing. Specifically, the “perpetuation” is to store data into a non-volatile auxiliary storage device (HDD, SDD, or the like). The output process and the collection process of the logs are separated from each other because a high processing load is generally required in the perpetuation process of the log data using the storage program 116.

The client machine 117 is a device that executes the client program 114. The client machine 117 may be a consumer device including a PC, a smartphone, a tablet terminal, or a car navigation system.

The client program 114 calls the function provided by the server program 102. The client program 114 transmits a request (request for calling the server function) to the load balancer 111 using data communications via the WAN 112, and receives a response message. The client program 114 may be a web browser.

The log management machine 109 is a device that executes the log management program 115. The log management machine 109 may be a corporate device including a PC, a smartphone, or a tablet terminal.

In response to an entry from a user (for example, a system administrator), the log management program 115 transmits the log management command to the log management function processing unit 104, and presents the execution result to the user. The log management program 115 provides a user interface for transmitting the log management command to the log management function processing unit 104, and receives an entry from the user. Using the log management program 115, the user can refer to the pieces of log data (all pieces of log data in clusters) collected by the log collection processing unit 107. The log management program 115 may be a web browser.

The storage machine 110 is a device that executes the storage program 116. The storage machine 110 may be a server machine including a PC or a blade server.

The storage program 116 provides a perpetuation function and a search function of the log data. The storage program 116 may be a database program such as PostgreSQL or a Key Value Store (KVS) program such as HBase. Using the storage program 116, the search performance for the log data can be improved. In the case where the search performance for the log data does not matter, it is conceivable that the log data output by the log output processing unit 105 is used as it is. In this case, the log collection processing unit 107, the storage machine 110, and the storage program 116 are not needed, and the log management function processing unit 104 provides a log management function by using the log data output by the log output processing unit 105.

In order to disperse the load of each server machine, the load balancer 111 sorts and transfers requests from the client machine 117 to the server machine 101. The load balancer 111 sequentially transfers the requests to cluster nodes using the round robin method, or transfers the same to the cluster node with the lowest the processing load.

The system configuration illustrated in FIG. 1 is an example, and the embodiment is not limited to this configuration. In particular, an explanation for the server program is made in the embodiment, but the present invention can be applied to a stand-alone program other than the server program.

Next, hardware configurations of the server machine 101, the client machine 117, the log management machine 109, and the storage machine 110 in FIG. 1 will be described using FIG. 2.

In FIG. 2, an auxiliary storage device 206 is a non-volatile memory that stores a program 207 and log data 209.

The program 207 includes the client program 114, the log management program 115, the storage program 116, and the server program 102 that are executed by the respective machines, and each program is loaded into a main storage device 205 to be executed by a central processing unit 201.

Program data 208 is data necessary for executing each program. For example, in the case where the server program 102 uses JBoss, the program data 208 is all pieces of data included in the root folder of JBoss.

The log data 209 is data obtained in such a manner that the log output processing unit 105 adds necessary log tracking information to the log data output by the business logic processing unit 106, or is data with a table format that is perpetuated by the storage program 116. The log data 209 is generally stored as a file on a file system. It should be noted that the structure of the log data 209 with the log tracking information added will be described later in detail.

The central processing unit 201 is a processor that loads the program 207 or the program data 208 stored in the auxiliary storage device 206 into the main storage device 205, executes a command included in the program 207, and refers to the program data 208.

The main storage device 205 is a volatile memory that stores the program 207 or the program data 208 loaded from the auxiliary storage device 206 by the central processing unit 201, and is generally realized using a semiconductor storage device.

An input device 202 is a device that accepts an entry of data from the user, and includes a mouse and a keyboard.

An output device 203 is a device that outputs data to the user, and includes a display device such as a liquid crystal display and a printing device.

The input device 202 and the output device 203 are not needed if there is no need for interaction with the user.

A communication device 204 is connected to the networks such as the WAN 112 and the LAN 113, and transmits and receives data through the networks.

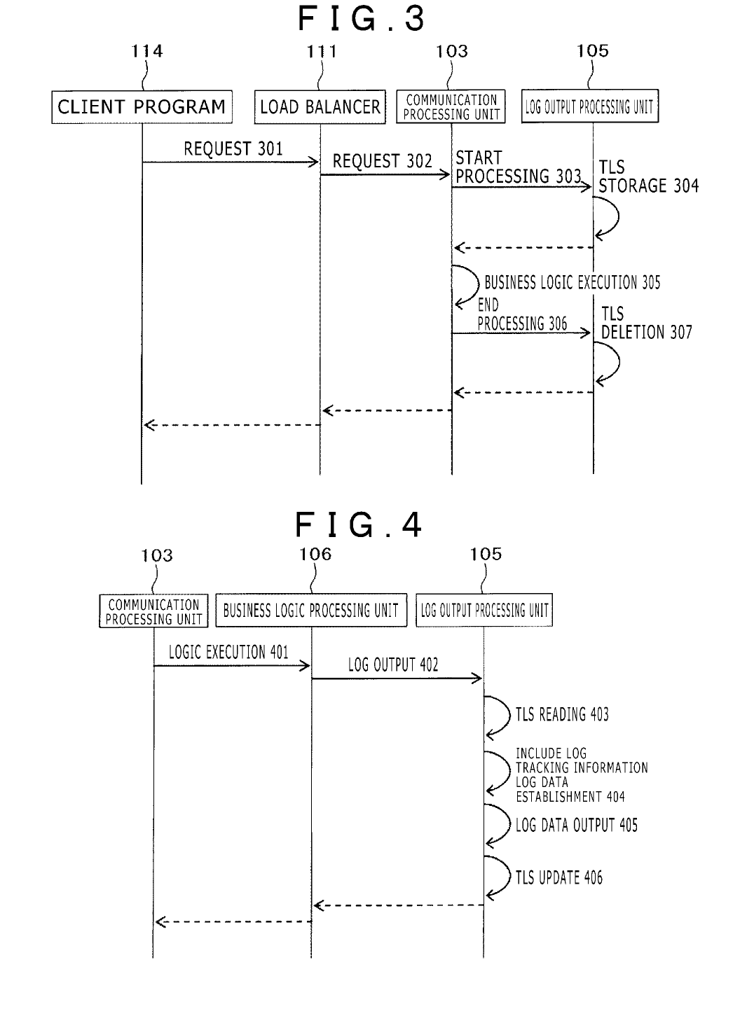

Next, each process related to logs performed by the log management system according to the embodiment of the present invention will be described using FIG. 3 to FIG. 5.

The start processing and end processing of outputting the logs will be described using FIG. 3.

First, the client program 114 transmits a request for calling the server function to the load balancer 111 (Sequence 301).

The load balancer 111 determines a cluster node to which the request transmitted from the client program 114 is transferred, and transfers the request to the communication processing unit 103 of the cluster node (Sequence 302).

Upon receiving the request transferred from the load balancer 111, the communication processing unit 103 passes a notification of starting to output the log and available log tracking information to the log output processing unit 105 (Sequence 303).

In Sequence 303, an Application Interface (API) for processing the sequence related to the log output processing unit 105 is released, and the communication processing unit 103 calls the API to perform a process. The followings are generally-available log tracking information.

user ID

session ID

sequence number

These pieces of log tracking information are output while being contained in the log data, so that the request transmitted from the client program 114 can be uniquely identified. Regarding these pieces of log tracking information, a user ID can be obtained by using mechanisms of basic authentication and digest authentication in an example of HTTP communications, and a session ID or a sequence number can be obtained by using a mechanism of Cookie. The communication processing unit 103 passes the obtained log tracking information as parameters to the log output processing unit 105 in Sequence 303.

Upon receiving the notification of starting to output the log and the log tracking information from the communication processing unit 103, the log output processing unit 105 stores the log tracking information into the TLS (Sequence 304). Although not illustrated in FIG. 3, the log output processing unit 105 actually requests the server basic middleware 108 to store the data into the TLS. In the case of Java (registered trademark), the process is performed by using the method calling of the java.lang.ThreadLocal class. The request transmitted from the client program 114 is supposed to be processed by a single thread, and thus the log tracking information stored in the TLS can always be referred to during the process of the request.

The log output processing unit 105 can store independently-generated log tracking information into the TLS, in addition to the log tracking information passed from the communication processing unit 103. The log output processing unit 105 generates a unique session ID (hereinafter, referred to as “LSID” which is an abbreviation for Local Session ID) that can uniquely specify the request in the same cluster node and stores the same into the TLS, so that the request in the cluster node can be identified in communications in which the unique session ID (corresponding to that passed from the communication processing unit 103 as the log tracking information in Sequence 303, and hereinafter, referred to as “GSID” which is an abbreviation for Global Session ID) is not set in the cluster system. In addition, even in the case of a request in which the GSID is set, the log data can be tracked using the LSID in the limited specific cluster node, thus improving the convenience.

After the calling process in Sequence 303 is completed, the communication processing unit 103 calls the business logic processing unit 106 (not illustrated in FIG. 3) to execute a business logic (Sequence 305). The communication processing unit 103 determines the server module of the business logic processing unit 305 to be called on the basis of the content of the received request, and delegates the process of the request. The server module to which the process is delegated can freely output the log data therein.

If the process delegated to the server module is returned, the communication processing unit 103 notifies completion of the log output using the API released by the log output processing unit 105 (Sequence 306).

The log output processing unit 105 having received the notification of completion of the log output discards the data stored in the TLS as the log tracking information (Sequence 307). The log tracking information stored in the TLS is not released unless the thread is discarded or the TLS is expressly cleared. Accordingly, an unnecessary increase of the memory can be suppressed by performing the end processing.

It should be noted that the dotted arrows in FIG. 3 represent return of control, and return information is returned if necessary.

A log output process will be described using FIG. 4.

The communication processing unit 103 requests the business logic processing unit 106 to execute a logic (Sequence 401). Sequence 401 represents that the communication processing unit 103 called the API of the business logic processing unit 106 in Sequence 305 of FIG. 3.

The business logic processing unit 106 can output arbitrary log data by calling an API for log output of the log output processing unit 105 (Sequence 402). The log data may be a log ID that can uniquely identify a log, a log message, or a log level.

If the API for log output is called, the log output processing unit 105 reads the log tracking information stored in Sequence 304 of FIG. 3 from the TLS (Sequence 403).

The log output processing unit 105 combines the log tracking information read in Sequence 403 with the log data passed through the API for log output to newly establish log data with the log tracking information added (Sequence 404). The format of the newly-established log data is dependent on the implementation. However, the log data needs to be analyzed by, at least, the log collection processing unit 107. The log data that can be analyzed is log data that can restore the log tracking information and log data before conversion. The log data includes data in which the output order of information and separator character strings (“:” in the following example) between the pieces of output information are determined as shown below.

[date and time]:[session ID]:[user ID]:[sequence number]:[log ID]

In this case, [log ID] is an ID that uniquely identifies the log data passed for log output by the business logic processing unit 106.

The log output processing unit 105 stores the log data established in Sequence 404 into the auxiliary storage device 206 (Sequence 405). In this case, the log data is stored into the auxiliary storage device 206 on the same machine to make faster the speed of the storing process of the log data. However, the log data can be stored into a database of another machine.

The log output processing unit 105 updates updatable data included in the log tracking information (Sequence 406). In the update process, 1 is added to the sequence number.

The processes of Sequences 402 to 406 can be repeatedly executed depending on the implementation of the business logic processing unit 106. The sequences are repeated, so that the log data including the log tracking information is accumulated. The developer of the business logic processing unit 106 can output the log data with little awareness of addition of the log tracking information, thus improving the productivity of development.

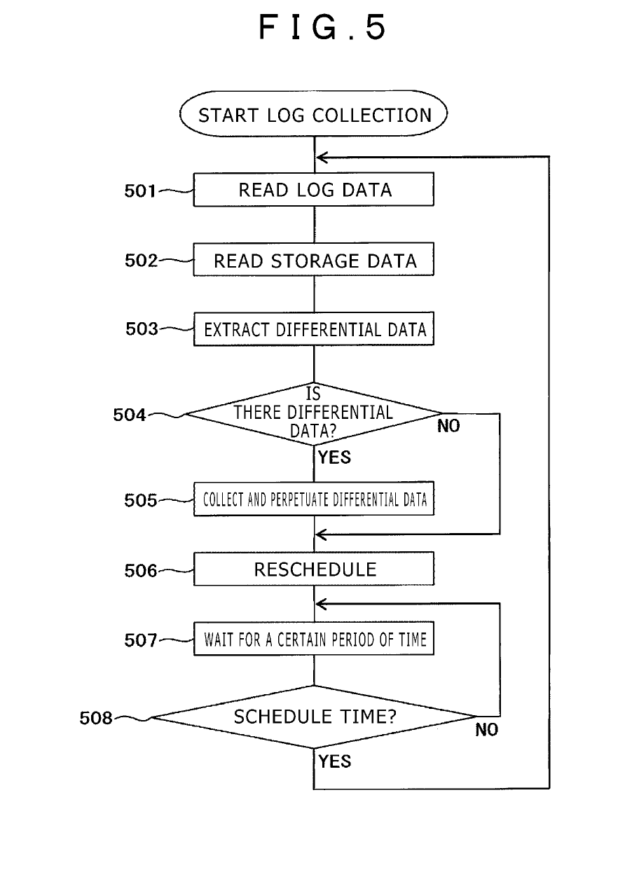

A log collection process will be described using FIG. 5.

The timing of starting the log collection process is dependent on the implementation. It is conceivable that the log collection is started by calling a log collection starting API of the log collection processing unit 107 at the time of starting the server program 102.

When collecting the logs, the log collection processing unit 107 reads the log data stored in a log file or the like by the log output processing unit 105 (Step 501). This step is executed to compare the collected log data (that is perpetuated in the database or the like) with uncollected log data. Accordingly, it is not necessary to read the all pieces of log data. It is only necessary to read the last output log data.

The collected log data described in Step 501 is read by the log collection processing unit 107 using the storage program 116 (Step 502). Similarly to the process of Step 502, it is not necessary to read the all pieces of collected log data. It is only necessary to read the last collected log data.

A difference between the uncollected log data and the collected log data read in Step 501 and Step 502 is extracted by the log collection processing unit 107 (Step 503). The output date and time of the last collected log data is compared with the output date and time of the last output uncollected log data. If a difference is recognized, the difference is extracted.

The log collection processing unit 107 determines whether or not the differential data has been extracted in Step 503 (Step 504). In the case where the differential data has been extracted (namely, in the case where the log data to be collected exists), the log collection processing unit 107 proceeds to Step 505. In the case where the differential data has not been extracted (namely, in the case where no log data to be collected exists), the log collection processing unit 107 proceeds to Step 506.

In the case where the result of the determination in Step 504 shows that the differential data has been extracted, the log collection processing unit 107 perpetuates the differential data extracted in Step 504 in a storage such as a database using the storage program 116 in Step 506 (Step 505). The pieces of log data dispersed in the clusters are collected in the storage shared by the server system, so that the pieces of log data of the whole server system can be centrally managed.

In the case where the result of the determination in Step 504 shows that the differential data has not been extracted, the date and time when the log data is next collected is scheduled (Step 506). The scheduling method is dependent on the implementation. For example, there is a method in which an administrator of the server system sets the scheduled date and time using the log management program 115, and the scheduled date and time is read in Step 507, so that the next collection date and time is determined. The administrator of the system may operationally set inspection frequencies in such a manner that the logs are collected once a day or an hour.

Next, the log collection processing unit 107 waits for a certain period of time until the next collection process starts while stopping the thread (Step 507). The waiting time is dependent on the implementation. The log collection processing unit 107 may wait for a predetermined period (for example, one hour or the like), or may wait until the scheduled date and time set in Step 506.

Next, after the log collection processing unit 107 waits for a certain period of time in Step 507, it is determined whether or not it is the scheduled date and time set in Step 506 (Step 507). In the case where it is the scheduled date and time, the log collection processing unit 107 returns to Step 501 to start the collection process. In the case where it is not the scheduled date and time, the log collection processing unit 107 returns to Step 507, and waits for a certain period of time again.

By repeating Steps 501 to 508, the pieces of log data in each cluster node are perpetuated in the database or the like shared by the server system and can be centrally managed.

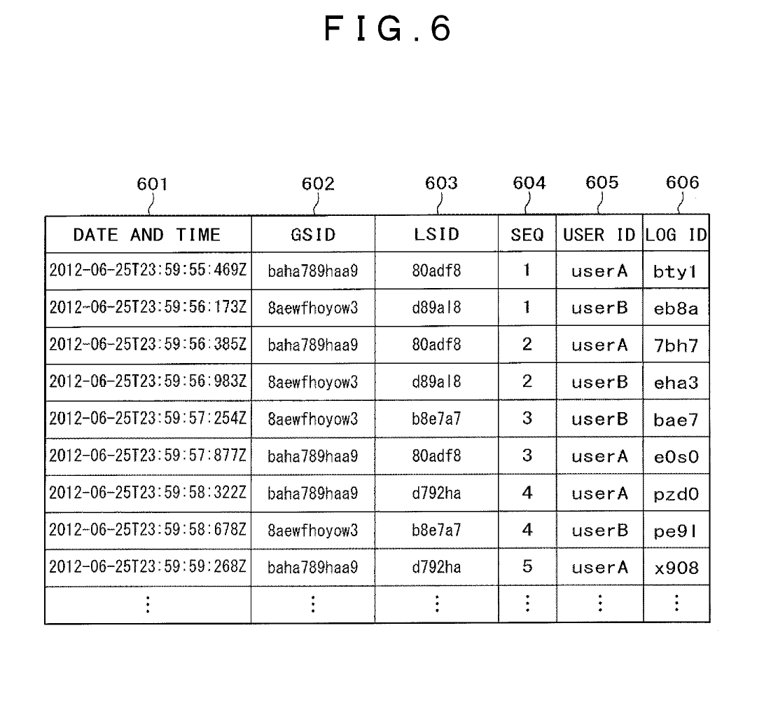

Next, a management format in the case where the log data with the log tracking information added is handled by the storage program 116 will be described using FIG. 6.

The format in which the respective items of the log data with the log tracking information added are separated using the separator character strings has been described above. However, it is actually convenient in searching or data processing if the data can be handled by RDB software such as SQL. Therefore, FIG. 6 explains a case in which the pieces of log data with the log tracking information added that are collected by the log collection processing unit 107 and perpetuated by the storage program 116 are stored as a log table.

As shown in FIG. 6, various pieces of information are defined in separate table columns of the log table. In FIG. 6, for example, the output date and time of log data, the GSID, the LSID, the sequence number (SEQ), the user ID, and the log ID are stored in a column 601, a column 602, a column 603, a column 604, a column 605, and a column 606, respectively. In the format of the log table, the columns 601 to columns 606 are columns to store the log tracking information.

The output date and time of the log data in the column 601 is a character string representing the date and time when the log is output. The GSID in the column 602 is a character string representing a GSID that is a unique session ID in the cluster system as described above. The LSID in the column 603 is a character string representing an LSID that is a session ID for uniquely identifying a request in the same cluster node. The sequence number in the column 604 is a serial number representing the order of outputting the log data and is a unique number in the same thread. The user ID in the column 605 is a character string representing a user who logs on from a client to request the server to perform a process. The log ID in the column 606 is a character string for uniquely identifying the log data passed for log output by the business logic processing unit 106.

As described above, the log tracking information and various pieces of information included in the log data are managed in a table format, and SQL sentences or the like are used, so that the search performance for the log data can be improved. In a conventional log output method, the format of the log data is not unified. Thus, it has been difficult to individually manage the information. In order to individually manage the information, it is necessary to determine which part of the log data the information is described in.

By managing the information in a table format as described above, it is possible to determine which part of the log data each information piece is stored in, and the information can be easily and individually managed.

The example in which the log data with the log tracking information added is managed in a table format has been described above. The example does not limit a management format, but other formats may be employed as long as the log data can be centrally managed.

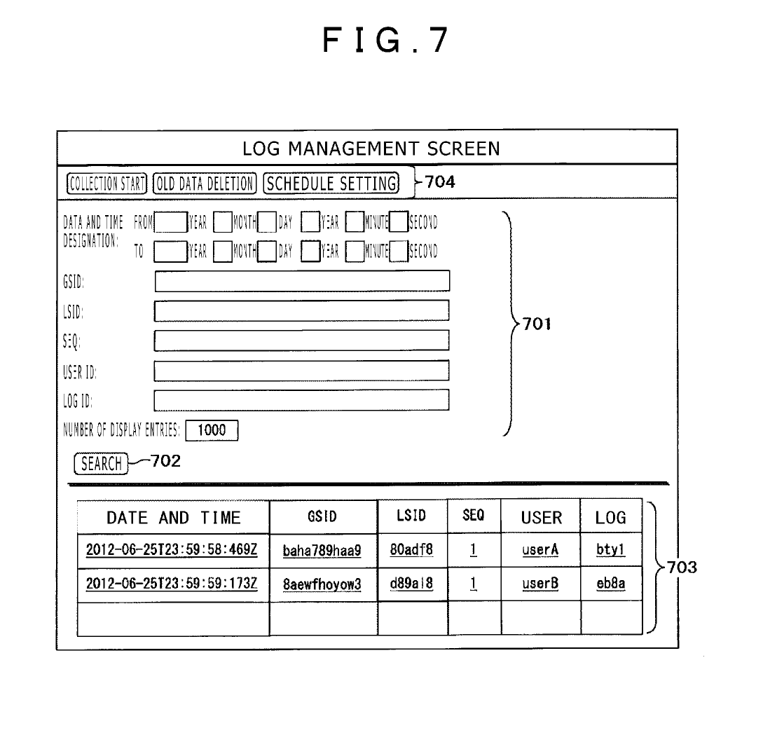

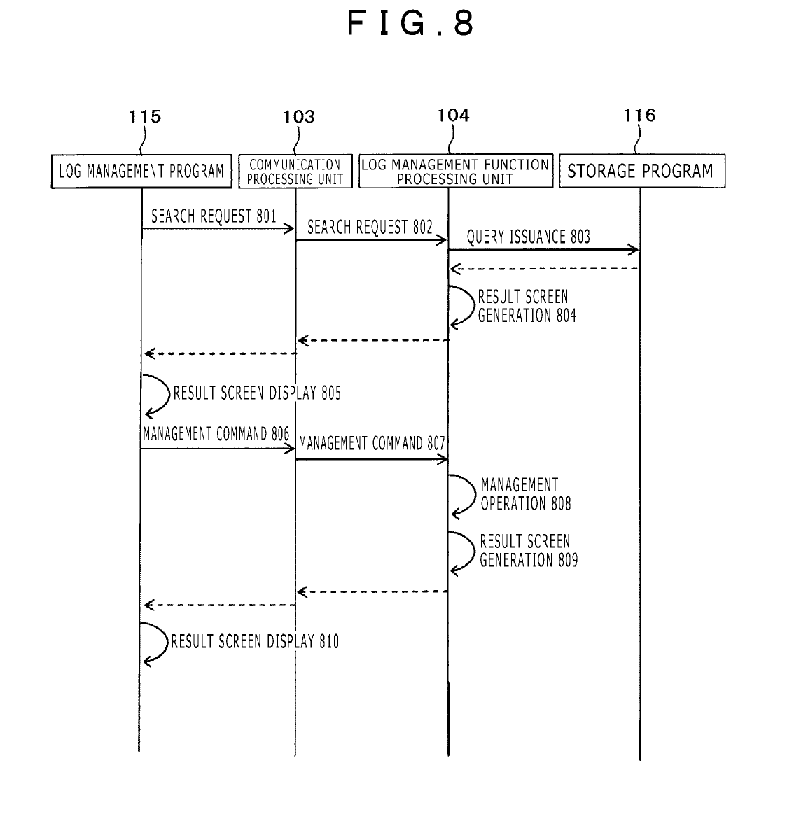

Next, a user interface of a management screen for log data and a process at the time of a log search will be described using FIG. 7 and FIG. 8.

The management screen for log data in FIG. 7 is used by an administrator of the server system when tracking log data. The management screen is a screen output by the log management program 115 to the output device 203 of the log management machine 109. In addition, the log management program 115 is a web browser.

In an area 701, entry fields for inputting search conditions for log data are provided. The administrator of the server system inputs the conditions for log data to be tracked in the area 701, and presses a button 702, so that the search results are displayed in a table 703. “The number of display entries” input in the area 701 represents the maximum number of pieces of log data displayed in the table 703. In the case where “1000” is input as shown in the drawing, first 1000 pieces of log data matching the search conditions are displayed in the table 703.

The date and time designation, the GSID, the LSID, the sequence number, and the log ID shown in the area are the same as those explained in FIG. 6.

A hyperlink (displayed using an underline in FIG. 7) is set for each information piece of the search results displayed in the table 703. By clicking the hyperlink, the administrator can refine the search using the information. For example, by clicking the hyperlink set for “user B” in the “user ID” column, only a search result in which the user ID is “user B” can be displayed among the search results displayed in the table 703. This mechanism is incorporated into the interface, so that the log can be easily tracked.

An area 704 is a field in which a group of buttons for executing the log management commands is disposed. If a “collection start” button is pressed using a pointing device such as a mouse, a management command for immediately starting collection of log data irrespective of the settings of the scheduled date and time is executed. If an “old data deletion” button is pressed, a management command for deleting collected old log data from each server machine 101 is executed. By pressing a “schedule setting” button, a management command for setting the date and time to start the log collection process is executed. It should be noted that dialog boxes and the like for setting the date and time for scheduling are not displayed.

With reference to FIG. 8, processing sequences performed when the log management program 115 transmits a search request and a management command to the log management function processing unit 104 in response to an entry on the log data management screen shown in FIG. 7 will be described.

The log management program 115 transmits a search request for log data to the communication processing unit 103 (Sequence 801). When the “search” button 702 of FIG. 7 is pressed, the log management program 115 transmits the search conditions input in the field 701 to the communication processing unit 103.

The communication processing unit 103 transmits the search conditions received from the log management program 115 to the log management function processing unit 104 (Sequence 802).

The log management function processing unit 104 establishes an SQL query on the basis of the search conditions received from the communication processing unit 103, and transmits the SQL query to the storage program 116 (Sequence 803).

The log management function processing unit 104 generates HTML representing a search result screen on the basis of the execution result of the SQL query returned from the storage program 116 (Sequence 804).

The log management program 115 displays the search result returned from the log management function processing unit 104 on a browser screen (Sequence 805).

Sequences 801 to 805 are repeated every time the search is executed.

On the other hand, when each button provided in the area 704 of FIG. 7 is pressed, the log management program 115 transmits a management command in accordance with the type of button to the communication processing unit 103 (sequence 805).

The communication processing unit 103 transmits the management command received from the log management program 115 to the log management function processing unit 104 (Sequence 807).

The log management function processing unit 104 executes a command of starting log collection, a command of deleting old log data, or a command of resetting log collection schedules in accordance with the type of management command received from the communication processing unit 103 (Sequence 808).

The log management function processing unit 104 generates HTML representing an execution result screen on the basis of the execution result of the log management command (Sequence 809).

The log management program 115 displays the execution result returned from the log management function processing unit 104 on a browser screen (Sequence 810). The screen configuration of the execution result is dependent on the implementation.

Sequences 806 to 810 are repeated every time the log management command is executed.

The method has been described above in which HTML is generated on the web-based management screen for log data to display a screen and the log data is processed using an RDB. However, the same process can be performed using a dedicated protocol and management software.

What is claimed is:

1. A log management system comprising:
a computer including a central processing unit, a main storage device, an auxiliary storage device, and a communication device; and
another computer connected by the communication device via a network,
the computer including a business logic processing section that executes a process in response to a request from the other computer and a log output processing section that executes a process related to output of log data that is a record of a process,
wherein upon receiving an output starting request of the log data from the business logic processing section, the log output processing section holds log tracking information that uniquely identifies a log from the start of output of log data to the end of output of the same into a thread local storage on the main storage device, and
upon receiving an output request of the log data from the business logic processing section, the log output processing section adds the log tracking information held in the thread local storage to a log output from the business logic processing section to be output to the auxiliary storage device.

2. The log management system according to claim 1,
wherein the computer further includes a communication processing section that executes a communication process with the other computer,
upon receiving a request from the other computer, the communication processing section makes an output starting request of the log data to the log output processing section, and then requests the business logic processing section to process the request, and
when the process of the request by the business logic processing section is completed, the communication processing section makes a log data output stopping request to the log output processing section.

3. The log management system according to claim 1, wherein the computer is a cluster node of a cluster system that is configured using a plurality of computers and is operated in cooperation with each other.

4. The log management system according to claim 3,
wherein the cluster system has a storage area shared among the cluster nodes,
the computer further includes a log collection processing section, and
when the log collection processing section that regularly inspects update conditions of the log data with the log tracking information added detects an update of the log data with the log tracking information added, the update portion of the log data with the log tracking information added is stored in the storage area.

5. The log management system according to claim 4, wherein the log data with the log tracking information added stored in the storage area has a table structure in which the log tracking information and the output log data are stored into separate columns.

6. The log management system according to claim 3,
wherein the log tracking information is configured using some or all of:
a user ID that uniquely identifies a user;
a global session ID that uniquely identifies a series of communication sessions between the computers via the network in the cluster system;
a local session ID that uniquely identifies a communication session in the cluster node in the cluster system;
a sequence number that represents the output order of log data using a value; and
log data output date and time.

7. The log management system according to claim 4,
wherein the computer further includes:
a section that allows the log collection processing section to regularly inspect update conditions of the log data with the log tracking information added; and
a section that immediately executes an inspection of the log data with the log tracking information added.

8. The log management system according to claim 1,
wherein the computer further includes:
a section that searches for the log data with the log tracking information added output to the auxiliary storage device; and
a section that deletes the log data with the log tracking information added output to the auxiliary storage device.

9. A log management method which is executed on a computer that includes a central processing unit, a main storage device, an auxiliary storage device, and a communication device, and is connected to another computer by the communication device via a network, the method comprising:
receiving a request for a process from the other computer via the communication device by the central processing unit;
starting output of a log that is a record of the process by the central processing unit;
stopping output of the log that is a record of the process by the central processing unit;
generating a thread for the request for the process by the central processing unit;
securing, for the thread, a thread local storage that is a dedicated area storing data used for the thread on the main storage device by the central processing unit;
holding log tracking information that can uniquely identify output of the log from the start of output of the log to the end of output of the same into the thread local storage during the process by the central processing unit; and
adding the log tracking information to the output log and outputting the log data with the log tracking information added to the auxiliary storage device by the central processing unit.

10. A log management system comprising a plurality of computers each of which includes a central processing unit, a main storage device, an auxiliary storage device, and a communication device, and is connected to another computer by the communication device via a network,
wherein the plurality of computers include a log management computer having a display device and cluster nodes of a cluster system that is operated in cooperation with each other,
the cluster system has a storage area shared among the cluster nodes,
log tracking information that can uniquely identify output of a log from the start of output of the log to the end of output of the same is added to the log output during the process by the cluster nodes to be held into the storage area as a log table storing the log tracking information into separate columns during the process by the cluster nodes,
a log management screen is displayed on the display device of the log management computer,
the log management screen has fields into which search conditions related to the log tracking information of the log table are input, a display element that instructs search execution, and a field that displays search execution results,
each item of the display of the search results displayed in the field displaying the search results can be selected by an input device, and
when a user selects the selectable information, a refine search is performed to display data of the log table corresponding to only the selected information.
